(19) United States
(12) Patent Application Publication
(10) Pub. No.: US 2009/0116890 A1
(43) Pub. Date: May 7, 2009

(54) DECURL DEVICE, IMAGE FORMING APPARATUS PROVIDED WITH DECURL DEVICE AND FINISHING APPARATUS PROVIDED WITH DECURL DEVICE

(75) Inventors: Kunihiro KAWACHI, Kokubunji-shi (JP); Kyoichi MIZUNO, Tama-shi (JP)

Correspondence Address: CANTOR COLBURN, LLP, 20 Church Street, 22nd Floor, Hartford, CT, 06103, US

(73) Assignee: Konica Minolta Business Technologies, Inc., Tokyo (JP)

(21) Appl. No.: 12/264,534

(22) Filed: Nov. 4, 2008

(30) Foreign Application Priority Data
Nov. 7, 2007 (JP) JP2007-289417

(51) Int. Cl. G03G 15/00

(52) U.S. Cl. 399/406

(57) ABSTRACT

A decurl device which corrects a curl of a sheet includes: a soft roller having a surface layer which is deformed by receiving a contact force; a hard roller which contacts the soft roller and deforms the surface layer of the soft roller; a driving section which drives independently each of the soft roller and the hard roller; and a control section which controls the driving section independently to drive the soft roller with a first line speed of a peripheral surface of the soft roller and drive the hard roller with a second line speed of a peripheral surface of the hard roller.

### RELATED APPLICATION

This application is based on Japanese Patent Application NO. 2007-289417 filed on Nov. 7, 2007 in Japanese Patent Office, the entire content of which is hereby incorporated by reference.

### TECHNICAL FIELD

The present invention relates to a decurl device which corrects a curl of a sheet.

### BACKGROUND OF THE INVENTION

In an electrophotographic image forming apparatus, an image is fixed onto a sheet through heat processing, the sheet is heated reaching to a high temperature of nearly 200 degrees centigrade, water dehydration from the sheet by heat causes a difference of contraction ratio between the front and the back side of the sheet and a curling or a waving occur.

The curling and the waving may remain at the sheet after the image processing in case when the sheet to be used itself has a curling, other than the curling caused by the above mentioned processing to the sheet.

The sheet with the curling or the waving has a low aligning property at a delivery tray as well as has a low conveyance property in a finishing apparatus and may cause a jamming of the sheet in the finishing apparatus.

For this reason, technologies for correcting the curl of the sheet after an image has been formed have been developed.

In Unexamined Japanese Patent Application No. 04-251067, a decurl mean which controls a decurl amount based on thicknesses of sheets is proposed, as the curling of the sheets depends on the types of sheets.

Further, in Unexamined Japanese Patent Application No. 2004-29563, changing a decurl amount by adjusting a difference of speed between a heat roller and a pressure roller is proposed.

The decurling generally employs an art in which the sheet is bent to the opposite direction to the curl direction and it is necessary to bends the sheet according to the amount of the curl, a type of the sheet, a thickness of the sheet and the like.

If the decurl is uniformly performed regardless of these factors, such a problem that the curling remains, a curling to the opposite side newly occurs by an excessive uncurling occurs.

In Unexamined Japanese Patent Application No. 04-251067, to solve these problems, a relative position of the roller and the belt which form a nip portion for correcting curl is changed according to the thickness of the sheet.

And in Unexamined Japanese Patent Application No. 2004-29563, changing the amount of correcting curl by changing the speed ratio of a heat roller and a pressure roller according to the image information is proposed.

In Unexamined Japanese Patent Application No. 04-251067, the nipping portion is formed by contacting the roller to the belt so that the belt bends and the nip portion corrects the curling of the sheet.

However the curling adjusting function of these decurl devices does not suffice.

That is, in Unexamined Japanese Patent Application No. 04-251067, the curvature of the roller being constant makes the amount of the correction of the curling be limited although the roller changes the amount of correction of the curling by changing the amount of the deformation of the belt.

And the decurl device which uses the belt and the roller has a problem that the size becomes large. Especially in case when the decurl amount is adjustable, the large space occupied by the decurl device results in a big size of the apparatus.

The decurl device, like the paper discharging device of the image forming apparatus and the paper inlet section of the finishing device, is mounted in a limited space, therefore in case when the decurl amount is made to be adjustable for the decurl device using the belt and roller, the decurl device becomes difficult to be mounted in the image forming apparatus or in the finishing apparatus.

In Unexamined Japanese Patent Application No. 2004-29563, the decurl amount is changed by changing the speed difference of the heat roller and the pressure roller. However, in this case, also, the adjusting function of the amount of the decurl does not suffice.

That is, the difference of the speeds is required to be large in order to make the amount of the correcting curl, however making the amount of the correcting curl may cause the deficiency in image quality as the sheet carrying the unfixed toner image thereon passes between the two rollers.

Further, the curvatures of the heat roller and the pressure roller are decided by the performance required for fixing, the curvatures appropriate for correcting curl do not form and the required amount of correcting curl can not be obtained.

It is an object of the present invention to provide the decurl device which solves the above mentioned problems in the conventional decurl device, is compact and has a function sufficient for adjusting amount of correcting curl, the image forming apparatus provided with the decurl device and the finishing apparatus provided with the decurl device.

### SUMMARY OF THE INVENTION

The above object is achieved by the following inventions:

1. A decurl device which corrects a curl of a sheet, the decurl device comprising:

a soft roller having a surface layer which is deformed by receiving a contact force;

a hard roller which contacts the soft roller and deforms the surface layer of the soft roller;

a driving section which drives independently each of the soft roller and the hard roller; and

a control section which controls the driving section independently to drive the soft roller with a first line speed of a peripheral surface of the soft roller and drive the hard roller with a second line speed of a peripheral surface of the hard roller.

2. An image forming apparatus which forms an image onto a sheet, the image forming apparatus comprising:

an image forming section which forms the image onto the sheet;

a fixing device which fixes the image onto the sheet; and,

a decurl device which corrects a curl of the sheet which is fixed,

wherein the decurl device comprises,

a soft roller having a surface layer which is deformed by receiving a contact force;

a hard roller which contacts the soft roller and deforms the surface layer of the soft roller;

a driving section which drives independently each of the soft roller and the hard roller; and

a control section which controls a first line speed of a peripheral surface of the soft roller and a second line speed of a peripheral surface of the hard roller.

3. A finishing apparatus which performs a finishing process to a sheet, the finishing apparatus comprising:

a finishing section which performs the finishing process to the sheet; and

a decurl device which corrects a curl of the sheet,

wherein the decurl device comprises,
a soft roller having a surface layer which is deformed by receiving a contact force;

a hard roller which contacts the soft roller and deforms the surface layer of the soft roller;

a driving section which drives independently each of the soft roller and the hard roller; and

a control section which controls a first line speed of a peripheral surface of the soft roller and a second line speed of a peripheral surface of the hard roller.

### BRIEF DESCRIPTION OF THE DRAWINGS

FIG. 1 is a general view of an image forming apparatus according to an embodiment of the present invention.

FIG. 2 is a schematic diagram of the decurl device according to the embodiment of the present invention.

FIG. 3 is a block diagram showing a control system of the decurl device according to the embodiment of the present invention.

FIG. 4 is a diagram showing the change in time of the difference of speed between the soft roller and the hard roller.

### DETAILED DESCRIPTION OF THE PREFERRED EMBODIMENT

While a preferred embodiments of the present invention will be described below, the present invention is not limited to the embodiments.

### <Image Forming Apparatus>

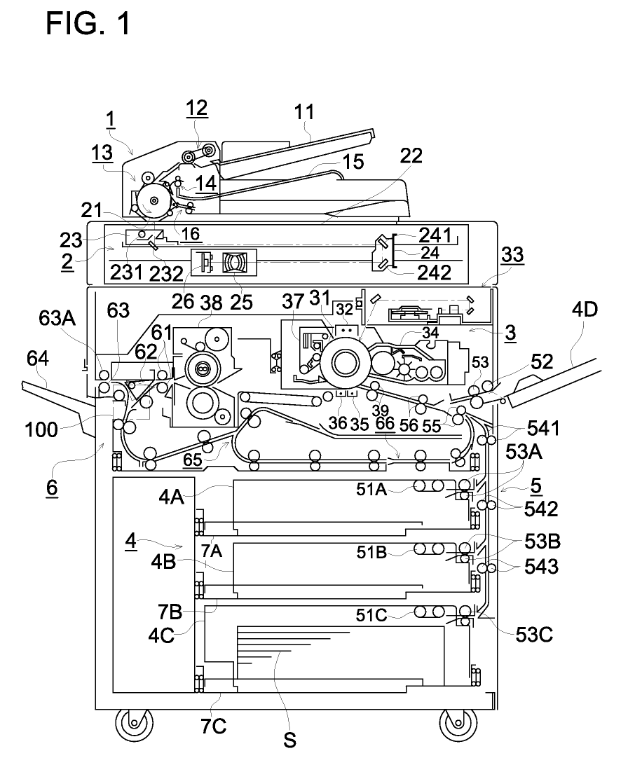

FIG. 1 illustrates a general view of an image forming apparatus of the embodiment of the present invention.

The image forming apparatus of the embodiment of the present invention includes, thereon, an automatic original document feeder 1 and, therein, an image reading section 2, an image forming section 3, a fixing device 38, a sheet stacking section 4, conveyance section 5, sheet exiting/re-feeding section 6, and a decurl section 100.

The auto original document feeder 1 is provided at the upper part of the image forming apparatus, feeds out original document sheets one by one, conveys each sheet to a position where the image of the original document sheet is read, and exits the sheet after the image is read. The auto original document feeder 1 comprises an original document table 11 for placing the original documents thereon, an original document separating device 12 for separating the original documents placed on the original document table 11, an original document conveyance device 13 for conveying the original documents separated by original document separating device 12, an original document ejecting device 14 for ejecting the original documents conveyed by the original document conveyance device 13, an ejected original document table 15 for storing original documents ejected by original document ejecting device 14 and an original document flipping device 16 for flipping the front and the back of the original document sheet when image of each side thereof is read.

The original document separating device 12 separates a plurality of original document sheets placed on the original document placing table 11 into individual original document sheet and conveys the individual original document sheet one by one. The original document conveyance device 13 conveys the original document sheet separated and conveyed by the original document separating device 12 and the image reading section 2 provided under the original document conveyance device 13 reads image of the original document sheet through a Slit 21. The original document ejecting device 14 ejects the original document sheet of which image has been read to the ejected original document table 15.

When images at both sides of the original document sheet are read, the original document flipping device 16 flips the front and the back of the original document sheet of which image of the front side has been read, and again the original document conveyance device 13 conveys the original document sheet and image reading section 2 reads the image of the backside through a Slit 21. The original document ejecting device 14 ejects the original document sheet of which image has been read to the ejected original document table 15. This process repeats the number of times which is the number of the original document sheets stored on the original document placing table 11 and the images of the original document sheet are read.

The automatic original document feeder 1 is structured to pivot upward. The automatic original document feeder 1 is designed to be lifted to clear the area on a platen glass 22 so that the original document can be directly placed thereon. The image of the original document sheet is read while the original document sheet is conveyed by the original document conveyance device 13, however the image of the original document sheet may be read when the original document sheet conveyed by the original document conveyance device 13 is stationary placed on the platen glass 22.

The image reading section 2 is provided at an upper part in the image forming apparatus and obtains image data by reading images on the original documents. The image reading section 2 comprises a slit 21 which is a slit shaped opening for reading image, platen glass 22 which is a document table for placing the original document sheet thereon, the first mirror unit 23 structured integrally by lamp 231 for irradiating the original document and a first mirror 232 to reflect reflected light from the original document, a V mirror unit 24 structured integrally by a second mirror 241 for reflecting reflected light from the first mirror 232 and a third mirror 242, an imaging lens 25 for forming images on a CCD being a solid state image sensor and CCD 26 structured in a line shape to convert an optical image into electric signals.

The first mirror unit 23 and the V mirror unit 24 move toward the left direction in FIG. 1 and the first mirror unit 23 positions below the slit 21 when the original document being sent by automatic original document feeder 1 is read by image reading section 2. Then the lamp 231 irradiates the original document sheet conveyed to a position above of the slit 21 by the original document conveyance device 13 and the reflected light from the original document sheet into CCD 26 through the first mirror 232, the second mirror 241, third mirror 242, and imaging lens 25. CCD 26 converted the reflected light to electrical signal by performing a photoelectrical conversion.

In case when the original document sheet is placed directly on platen glass 22, the image of the original document sheet is read by moving first mirror unit 23 and V mirror unit 24 toward the right direction in FIG. 1.

An image forming section 3 forms image based on the image data read by the image reading section 2 onto a sheet S being conveyed at a predetermined speed. The image forming section 3 forms image by using electrophotographic process.

The image forming section 3 comprises a photosensitive drum 31 which has a photoconductive sensitization layer on its surface and carries toner image, a charging device 32 for uniformly charging the surface of the photosensitive drum 31, a laser writing device 33 which irradiating on the surface of the photosensitive drum 31 and forms latent image, a developing device 34 forming a toner image by developing the latent image formed on the photosensitive drum 31, a transferring device 35 for transferring the toner image carried on the photosensitive drum 31 onto the sheet S, a separating device 36 for separating the sheet from the photosensitive drum 31, and a cleaning device 37 which cleans photosensitive drum 31 after completing a transferring process. The charging device 32, the laser writing device 33, the developing device 34, the transferring device 35, the separating device 36, and the cleaning device 37 are disposed around the photosensitive drum 31

A fixing device 38 conveys the sheet S by a heating roller and a pressing roller and fixes the toner image onto the sheet S during a process of the conveyance.

The photosensitive drum 31 rotates clockwise driven by a driving section (not shown in drawing) and is charged uniformly by the charging device 32, the latent image is formed by the laser writing device 33 which starts irradiating synchronizing with the front edge of the sheet S conveyed out by a registration roller which is described later, and the toner image is formed thereon based on the image information by being developed by the developing device 34. The developed toner image is transfer by the transferring device 35 onto the sheet S being separately conveyed. The sheet S transferred the toner image is separated from the photosensitive drum 31 by the separating device 36 and is conveyed to the fixing device 38 and there the toner image is fixed onto the sheet S. On the other hand, the photosensitive drum 31 from which the toner image has been transferred to the sheet S continues rotating, is cleaned residual toner on the photosensitive drum 31 by the cleaning device 37, and serves for the next image formation.

In the embodiment, pre-transfer conveyance rollers 39 are disposed near the photosensitive drum 31 between the photosensitive drum 31 and the registration rollers 56 and the pre-transfer conveyance rollers 39 transfer sheets and contribute to increasing the conveyance force of the sheets. Conveyance rollers (no reference numeral is shown) and belt (no reference numeral is shown) which support the sheets from the bottom face of the sheets (opposite side of forming image) and convey the sheets separated by the separating device 36 are disposed between the separating device 36 and the fixing device 38.

A plurality of sheets S are stored in a sheet storing section 4. In the embodiment, the sheet storing section 4 comprises a first sheet storing section 4A, a second sheet storing section 4B and a third sheet storing section 4C and the sheet storing sections 4A to 4C are disposed in a multi stage below the image forming section 3. Those of sheets to be stored in the sheet storing sections 4A to 4C are OHP sheets and other various media, other than papers such as plain papers and recycled papers.

A conveyance section 5 conveys the sheet S from the sheet storing section 4 to the image forming section 3 and is configured to convey the sheet S stored in each of the sheet storing sections 4A to 4C to the image forming section 3. The specific construction and operation of the conveyance section 5 are described later in detail.

A sheet exiting/re-feeding section 6 discharges or re-feeds the sheet S conveyed by the conveyance section 5. The sheet exiting/re-feeding section 6 comprises, fixing discharging rollers 61 for discharging the sheet S from the fixing device 38 subjected to fixing, a conveying path switching section 62 for switching conveying path on the case when the sheet S discharged from the fixing discharging rollers 61 is discharged out of the image forming apparatus as it is and on the case when the sheet is discharged after flipping the front and the back of the sheet S or the sheet S is re-fed so as to be formed image on the back side of the sheet S, sheet discharging rollers 63A for ejecting the sheet S out of the image forming apparatus, a sheet discharge tray 64 which is disposed at the side of the image forming apparatus and stacks the sheet S discharged by the sheet discharging roller 63A, a reversing section 65 for reversing from front to back the sheet S re-fed, and a re-feeding section 66 for re-feeding the sheet S reversed at the reversing section 65 to the image forming section 3.

In the case when the sheet S formed image thereon is discharged as it is, that is, the image forming face corresponds to the upper side of the sheet S, the switching section 62 positions at the position shown by the dashed line in FIG. 1 and the sheet S is discharged to the discharge tray 64 out of the image forming apparatus by the fixing discharging rollers 61 and the sheet discharging roller 63A. In the case when the sheet S formed image thereon is discharged being reversed from front to back, that is, the image forming face corresponds to the lower side of the sheet S, the switching section 62 positions at the position shown by the solid line of FIG. 1, the sheet S discharged by the fixing discharging rollers 61 is once conveyed toward the reversing section 65, the conveyance direction is reversed after the sheet S passes through the conveying path switching section 62, then the sheet S is discharged to the discharge tray 64. Further, in the case when image is formed on the back side of the sheet S, the switching section 62 positions at the position shown by the solid line of FIG. 1, the sheet S discharged by the fixing discharging rollers 61 is once conveyed toward the reversing section 65, the sheet S is reversed from front to back through switching back the sheet S by the reversing section 65, and the sheet S is conveyed to the re-feeding section 66. Like the sheet conveyed from the sheet storing section 41 the sheet S conveyed to the re-feeding section 66 is conveyed to the image forming section after joining to the conveyance path between loop forming rollers 55 to be described later and intermediate rollers 541.

Next, the construction and the function of the conveyance section 5 are described.

As the sheet storing section for storing sheets S, four feeding trays including three feeding trays 4A, 4B and 4C are provided.

Corresponding to each feeding tray 4A, 4B and 4C, feed units 51A, 51B, and 52C which separate and feed out one sheet among the plurality of the sheets S and convey rollers 53A, 53B, and 53C which convey the sheet S fed out from the feed units 51A, 51B, and 51C are disposed.

Corresponding to a manual sheet feeding tray 4D, a feed out roller 52 and separating conveying rollers 53 for separating and conveying one sheet among the plurality of the sheets S

A feeding conveyance section for conveying the sheet S to the position of transferring comprises the registration rollers 56 and an intermediate conveyance section for conveying the sheet S to the registration rollers 56

The intermediate conveyance section comprises conveyance rollers 541, 542, 543, and 55 which convey the sheet S from conveyance rollers 53A, 53B, and 53C.

The reference numeral 39 indicates pre-transfer conveyance rollers disposed between the registration rollers and the transferring section.

Original document sheets are fed and read one by one by the automatic original document feeder 1 for image forming.

Or the original document sheet is placed on the platen glass 22 and is read by the image reading section 2

The image is formed onto the sheet S based on the image data acquired by the image reading or the image received from outside as described followings.

The toner image is formed on the photosensitive drum 31 through charging, irradiating and developing, and the formed toner image is transferred onto the sheet S by the transferring device 35.

The sheet S is separated and conveyed by one sheet by the feed units 51A, 51B, and 52C from feeding trays 4A, 4B and 4C to the registration rollers 56.

The sheet S is conveyed by the registration rollers 56 synchronizing with forming image on the photosensitive drum 31 and receives the toner image transferred by the transferring device 35.

The toner image transferred by the transferring device 35 is subject to fixing by the fixing device 38

The sheet S subject to fixing is switched corresponding to the straight discharging, the reverse discharging and the backside image forming by the conveying path switching section 62, and thereby is conveyed.

The sheet S is discharged to the sheet discharge tray 64 via the sheet discharging rollers 63A in the straight discharging.

After passing through the fixing device 38, the sheet S is conveyed downward, switches back and goes up, and is discharged to the sheet discharge tray 64 by the sheet discharging rollers 63A in the reverse discharging.

After passing through the fixing device 38, the sheet S is conveyed to the reversing section 65, reversed from front to back by the reversing section 65, and is re-fed to the transferring device 35, for the backside image forming.

The toner image to the back side is transferred by the transferring device 35 and fixed.

The sheet S subject to fixing is discharged to the sheet discharge tray 64 via the sheet discharging rollers 63A.

Reference numeral 100 is a decurl device which is disposed at a downstream side of the fixing device 38 and at an upstream side of the reversing section 65 and decurls the sheet S having fixed.

### <Decurl Device>

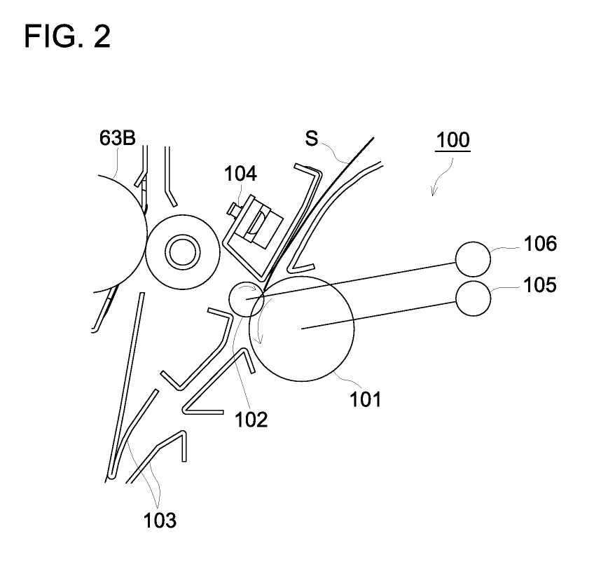

FIG. 2 is a schematic diagram of the decurl device according to the embodiment of the present invention.

The decurl device 100 according to the embodiment of the present invention comprises a soft roller 101, a hard roller 102 disposed facing to the soft roller, and a sheet sensor 104.

The decurl device 100 decurls the sheet S which has been discharged from the fixing device 38 and is to be discharged to the reversing section 65.

The decurl device may be disposed on the immediate down stream side of the fixing device 38 and all the sheets discharged from the fixing device may be decurled. Or the decurl device may be disposed at an inlet section of a finishing apparatus (not shown in drawings) which applies a finishing process to the sheet discharged from the image forming apparatus.

The decurl device 100 according to the embodiment of the present invention has a decurl section comprising a soft roller 101, a hard roller 102 to decurl the curl of one direction. However, the decurl device may have two decurl sections.

The reference numeral 103 is a guide member for guiding the sheet in the decurl device.

The reference numeral 63B is a discharge roller disposed at the reverse discharging path.

As shown in FIG. 1, the decurl device 100 is disposed at the branch conveyance path branching downward from the straight conveyance path which is horizontal and reaches from the fixing discharging rollers 61 to the sheet discharging rollers 63A, on the down stream side of the fixing device 38.

The soft roller 101 is a roller comprising a metal shaft core and a peripheral surface layer of polyurethane form around the metal shaft core.

The hard roller is formed of metals such as SUS, SAM and the like and may be formed of surface treated metal, further may be a roller coated with plastic material such as polytetrafluoroethylene.

The surface layer of the soft roller 101 is deformed by the hard roller 102 as shown in the drawing and forms the curved nip portion.

The curl of the sheet S which curves opposite to the direction of the curve of the nip portion is decurled by being bended by the nip portion.

In the example shown in the drawing, the sheet S which is conveyed downward is decurled so as to be concave at the left side surface.

The reference numeral 105 is a motor as a driving section for driving the soft roller 101 and the reference numeral 106 is a motor as a driving section for driving the hard roller 102. Each of the driving sections comprises a stepping motor of which the rotation speed can be controlled independently.

The hard roller 102 is enabled to be displaced selectively at the position shown in the drawing that is a first position where the soft roller 101 is deformed and at the second position which is a contact position which does not deform the soft roller 101 or a none-contact position. The hard roller 102 is displaced at the first position shown in the drawing in a decurl mode and is displaced at the second position in a none decurl mode.

In case of decurling a normal sheet that is of a plain paper formed image thereon in the decurl mode, a line speed on the peripheral surface of the soft roller 101 (first line speed) is set to be equal to a line speed of the peripheral surface of the hard roller 102 and the sheet S is decurled.

However in case when the decurl device is adjusted appropriately to the plain paper, the decurl amount is not sufficient or the curl remains for the paper with high stiffness such as a thick paper and a coating paper and the decurl amount is excessive and a curl of opposite direction is formed for a sheet with low stiffness such a thin paper.

When the line speed of the soft roller 101 is assumed to be VS and the line speed of the hard roller 102 is assumed to be VH, the decurls for various kinds of sheets are properly performed by changing the decurl condition for the thick paper, the coating paper and thin paper as following:

| | |
|---|---|
| Condition a: plain paper | VS = VH |
| Condition b: thick paper, coating paper | VS < VH |
| Condition c: thin paper | VS > VH |

In the Condition b, a force in a direction reducing the conveyance speed acts at the surface of the sheet S to the side of the hard roller 102 and a force of a direction promoting the conveyance speed acts at the surface of the sheet S to the side of the soft roller 101. Thereby the sheet S receives a force bending the sheet S toward the hard roller 102 and the decurl is enhanced.

In the Condition c, a force in a direction promoting the conveyance speed acts at the surface of the sheet S to the side of the hard roller 102 and a force of a direction promoting the conveyance speed acts at the surface of the sheet S to the side of the soft roller 101. Thereby the sheet S receives a force bending the sheet S toward the hard roller 102 and the decurl is reduced.

Changing one of the speed of the soft roller 101 and the speed of the hard roller 102 or changing the both speeds can make a speed difference between the two rollers.

Setting the conditions a, b, and c by making the speed difference of a few percent can perform the decurl appropriately.

In this decurl, the soft roller 101 may wear out by a friction of two rollers when the soft roller 101 and the hard roller 102 rotate with the speed difference, during a period in which the sheet does not pass through the decurl unit.

That is, the soft roller 101 wears out depending on the relation between the material of surface of the soft roller 101 and the material of surface of the hard roller 102.

Therefore, it is preferred that the speed difference of the soft roller 101 and the hard roller 102 is kept during passing the sheet and both rollers 101, 102 rotate with the same line speed, that is, it is preferred that the first line speed and the second line speed are equal, during a period without passing the sheet.

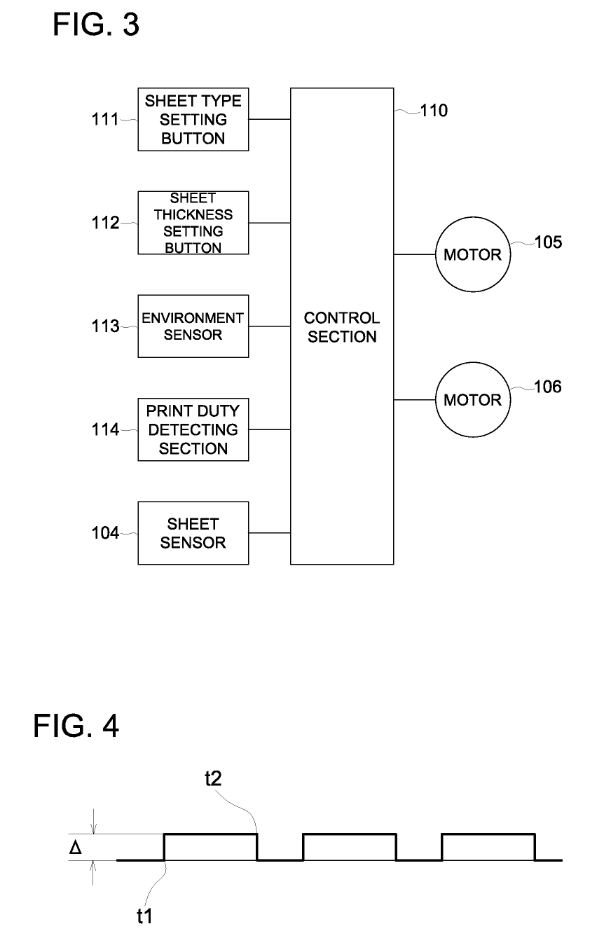

The following describes the operation of the decurl device described above, based on FIG. 3 and FIG. 4.

FIG. 3 is a block diagram showing a control system of the decurl device according to an embodiment of the present invention. FIG. 4 is a diagram showing a change of the speed difference between the soft roller and the hard roller in the decurl mode.

The reference numeral 110 is a control section which controls motors 105, 106. The reference numeral 111 is a sheet type setting button at an operation section (not shown in the drawings). The reference numeral 112 is a sheet thickness setting button at the operation section. The reference numeral 113 is an environment sensor for detecting temperature and humidity

The control section 110 comprises an information obtaining part and a control part, the information obtaining part obtains information from the sheet type setting button 111, the sheet thickness setting button 112 and the environment sensor 113, and the control part controls rotation speeds of the motors 105, 106 based on the information obtained by the information obtaining part.

The control section 110 selects any of Conditions a, b, and c, as well as sets various speed difference values in Condition b and in Condition c, and thereby sets appropriate decurl conditions for a variety of changes of the sheet type, the sheet thickness, the environment and the print duty.

The control of the first line speed VS and the second line speed corresponding to the sheet type and the sheet thickness are described above. Further corresponding to the environment, the control is made so that VS=VH when the temperature is normal and the humidity is normal; VS<VH when the temperature is high and the humidity is high; and VS>VH when the temperature is low and the humidity is low.

Further, The control section 110 performs a timing control of the rotation speed of the motors 105, 106 shown in FIG. 4, based on a sheet front edge detecting signal and a sheet rear edge detecting signal detected by the sheet sensor 104 for detecting sheet.

FIG. 4 shows a change in time of the speed difference between the soft roller 101 and the hard roller 102.

In FIG. 4, the speed difference Δ is zero during a period until the time t1 which is the period without passing the sheet when the sensor does not detects the sheet, and the soft roller 101 and the hard roller 102 rotate with the speed difference Δ which is not zero, during the period from the time t1, a predetermined time after the sensor detects the front edge of the sheet S to the time t2 the predetermined after the sensor detects the rear edge of the sheet S.

The above mentioned procedure repeats when the sheets continuously pass.

The predetermined time is the time period from the time when the sensor detects the sheet to the time when the sheet reaches to the nip portion formed between the soft roller 101 and the hard roller 102.

The control of the soft roller 101 and the hard roller 102 shown in FIG. 4 can be also performed based on a sheet detecting signal of a registration sensor which detects the sheet which passes the registration rollers 56 (shown in FIG. 1)

The abrasion or deterioration of the soft roller 101 can be prevented by the control shown in FIG. 4 as the soft roller 101 and the hard roller 102 rotate with the same speed during the period without passing the sheet even in case when the soft roller 101 and the hard roller 102 are driven and rotate with the speed difference.

According to the embodiment, the image forming apparatus and the finishing apparatus which have the decurl device which comprises the soft roller and the hard roller are compact and have the decurl function capable of sufficiently coping with changes such as sheet type, sheet thickness, environment, and a print duty, can be realized, as the decurling amount is adjusted by changing the speed difference of both rollers.

What is claimed is:

1. A decurl device which corrects a curl of a sheet, the decurl device comprising:
a soft roller having a surface layer which is deformed by receiving a contact force;
a hard roller which contacts the soft roller and deforms the surface layer of the soft roller;
a driving section which drives independently each of the soft roller and the hard roller; and
a control section which controls the driving section independently to drive the soft roller with a first line speed of a peripheral surface of the soft roller and drive the hard roller with a second line speed of a peripheral surface of the hard roller.

2. The decurl device of claim 1, wherein the decurl device has a first mode in which the first line speed equals to the second line speed.

3. The decurl device of claim 1, wherein the decurl device has a second mode in which the first line speed is faster than the second line speed.

4. The decurl device of claim 1, wherein the decurl device has a third mode in which the first line speed is slower than the second line speed.

5. The decurl device of claim 1, wherein the control section controls the drive section so as to drive and rotate the soft roller and the hard roller in a condition that the first line speed and the second line speed are different from each other during a sheet passing period in which the sheet passes through the nip portion between the soft roller and the hard roller, and so as to drive and rotate the soft roller and the hard roller in a condition that the first line speed and the second line speed are the same during a non sheet passing period in which the sheet does not pass through the nip portion between the soft roller and the hard roller.

6. The decurl device of claim 5, wherein the decurl device further comprises a sensor which detects a sheet passing and the control section controls the line speeds of the soft roller and the hard roller based on a signal from the sensor.

7. The decurl device of claim 1, wherein the decurl device further comprises an information obtaining section which obtains at least one information among a sheet type, a sheet thickness, an environment, and a print duty, and the control section controls at least one of the first line speed and the second line speed based on the information obtained by the information obtaining section.

8. An image forming apparatus which forms an image onto a sheet, the image forming apparatus comprising:
an image forming section which forms the image onto the sheet;
a fixing device which fixes the image onto the sheet; and,
a decurl device which corrects a curl of the sheet which is fixed,
wherein the decurl device comprises,
a soft roller having a surface layer which is deformed by receiving a contact force;
a hard roller which contacts the soft roller and deforms the surface layer of the soft roller;
a driving section which drives independently each of the soft roller and the hard roller; and
a control section which controls a first line speed of a peripheral surface of the soft roller and a second line speed of a peripheral surface of the hard roller.

9. A finishing apparatus which performs a finishing process to a sheet, the finishing apparatus comprising:
a finishing section which performs the finishing process to the sheet; and
a decurl device which corrects a curl of the sheet,
wherein the decurl device comprises,
a soft roller having a surface layer which is deformed by receiving a contact force;
a hard roller which contacts the soft roller and deforms the surface layer of the soft roller;
a driving section which drives independently each of the soft roller and the hard roller; and
a control section which controls a first line speed of a peripheral surface of the soft roller and a second line speed of a peripheral surface of the hard roller.
